(19) United States
(12) Patent Application Publication
(10) Pub. No.: US 2003/0073606 A1
(43) Pub. Date: Apr. 17, 2003

(54) Cleaning composition and method for using the same

(75) Inventors: Michael Alan Howell, Cincinnati, OH (US); Jacques Robert Rouillard, Loveland, OH (US); Sherri Denise Weems-Christie, Cincinnati, OH (US)

Correspondence Address: UNILEVER, PATENT DEPARTMENT, 45 RIVER ROAD, EDGEWATER, NJ, 07020, US

(73) Assignee: Diversey Lever, Inc.

(21) Appl. No.: 09/981,933

(22) Filed: Oct. 17, 2001

(51) Int. Cl. C11D 17/00

(52) U.S. Cl. 510/504; 510/218; 510/424; 510/499

(57) ABSTRACT

A cleaning composition suitable for use in an air compressor-free foam producing apparatus is described. The cleaning composition may be applied to a non-horizontal surface targeted for cleaning and the cleaning composition has a cationic and anionic moiety that forms a rod micellar formation.

### FIELD OF USE

The present invention is directed to a cleaning composition suitable for use in a foam producing device. More particularly, the present invention is directed to a cleaning concentrate having greater than about 35.0% by weight water, whereby the cleaning composition prepared therefrom is substantially free of isostearic acid and organic solvents.

### BACKGROUND OF THE INVENTION

It has become desirable to develop cleaning compositions for surfaces, especially hard surfaces, which are not horizontal in nature. In fact, many efforts have been expended in developing thickened and aqueous hard surface cleaning compositions. The thickened and aqueous hard surface cleaning compositions (i.e., high viscosity compositions) permit the cleaning of soiled surfaces in, for example, food and beverage processing plants, dairies, breweries and kitchens. The cleaning is achieved because such compositions remain on the soiled surfaces for a long enough time to act on the soil, a direct result of the high viscosity of the compositions.

Unfortunately, however, conventional thickened aqueous hard surface cleaning compositions are expensive to formulate and not always environmentally friendly. Moreover, because of their high viscosities, such compositions require the use of costly and cumbersome foam generating apparatuses that have water and air pressure supplies in order to produce a foam. Conventional compositions also tend to be difficult to rinse away.

It is of increasing interest to develop a cleaning composition that is not expensive to formulate, environmentally friendly and capable of being applied to a soiled surface with a device that only requires pressure generated from water to produce a foam (i.e., low viscosity). This invention, therefore, is directed to a cleaning concentrate that is greater than about 35.0% by weight water, and a cleaning composition prepared therefrom that is substantially free of isostearic acid and organic solvents. Moreover, the cleaning composition of the present invention is capable of being used to clean a surface with a foam producing apparatus that does not rely on air from an air compressor to produce foam.

### ADDITIONAL MATERIAL

Efforts have been disclosed for making cleaning composition. In U.S. Pat. No. 6,268,324, thickened hard surface cleaners having a rod micellar thickening system are disclosed.

Other efforts have been disclosed for making cleaning compositions. In U.S. Pat. No. 5,399,285, hard surface cleaners with an amine oxide surfactant are disclosed.

Still other efforts have been disclosed for making cleaning compositions. In U.S. Pat. No. 4,889,654, aqueous foam disinfecting solutions are disclosed.

### SUMMARY OF THE INVENTION

In a first aspect, the present invention is directed to a cleaning concentrate comprising:

a) optionally, an alkaline source;

b) a cationic moiety; and

c) an anionic moiety

wherein the cleaning concentrate is substantially free of isostearic acid and organic solvent, and the cationic and anionic moiety form rod micellar formations.

In a second aspect, the present invention is directed to a method for cleaning a soiled surface comprising the steps of:

a) applying to the surface a cleaning composition having a viscosity from about 1.0 to about 20.0 cps and comprising:

i) optionally, an alkaline source;

ii) a cationic moiety; and

iii) an anionic moiety,

the cationic moiety and the anionic moiety result in rod micellar formations;

b) allowing the cleaning composition to act on soil on the surface wherein about 60 to about 230 mls of the cleaning composition is applied to every square meter of the surface with a foam producing device to produce a foam layer having a thickness from about 0.2 to about 3.0 cm and a foam diameter from about 0.75 to about 2.5 mm.

As used herein, cleaning concentrate is defined to mean a composition that is preferably diluted with water before use. Cleaning composition, as used herein, is defined to mean a composition comprising water as a solvent or balance and comprising from about 0.5 to about 15.0%, and preferably, from about 0.75 to about 10.0%, and most preferably, from about 1.0 to about 5.0% by weight cleaning concentrate, based on total weight of the cleaning composition and including all ranges subsumed therein. Substantially free, as used herein, is defined to mean less than about 1.0% by weight, and preferably, less than about 0.75% by weight, and most preferably, less than about 0.50% by weight, based on total weight of cleaning concentrate cleaning composition or both. Rod micellar formation means a cationic moiety and anionic moiety form a rod micellar thickener composition.

### DETAILED DESCRIPTION OF THE PREFERRED EMBODIMENTS

There generally is no limitation with respect to the alkaline source employed in this invention other than that the alkaline source may be used in a cleaning composition. Typically, the alkaline source used in this invention is a base selected from an alkaline or alkaline earth metal hydroxide, including mixtures thereof. The preferred alkaline source used in the cleaning composition of the present invention is sodium hydroxide, potassium hydroxide or lithium hydroxide, with potassium hydroxide being especially preferred. Other alkaline sources which may be used in this invention include compounds like sodium carbonate, sodium tripolyphosphate, sodium silicate, ammonium hydroxide, mixtures thereof and the like.

Regarding the amount of alkaline source used in the cleaning concentrate of the present invention (if it is desired), typically from about 1.0 to about 20.0%, and preferably, from about 2.0 to about 15.0%, and most preferably, from about 5.0 to about 12.0% by weight of alkaline source is employed, based on total weight of the cleaning concentrate, and including all ranges subsumed therein.

The cationic moiety that may be used in this invention is limited only to the extent that it is a moiety capable of being used to make a rod micellar formation with an anionic moiety. The cationic moiety is often selected from an amine, quaternary amine, amine oxide, mixtures thereof and the like. Such a cationic moiety is preferably a trialkylamine having one or two alkyl groups and one or two alkylene oxide groups, as the case may be, with the preferred alkylene oxide group being propylene oxide, and most preferably ethylene oxide. Quaternary ammonium compounds suitable for use in this invention include those prepared from aliphatic amines, aromatic amines, trialkylamie oxides, mixtures thereof and the like. The most preferred cationic moiety used in the present invention is the amine oxide sold under the name Ammonyx MO, made commercially available by Stepan Company.

The anionic moiety that may be used in this invention is limited only to the extent that it is a moiety capable of being used to make a rod micellar formation with the cationic moiety described herein. Such an anionic moiety includes, but is not limited to, coupling agents or detergents that will preferably include a lipophilic moiety and/or a sulfonic, sulfuric, or carboxylic acid group. Illustrative examples of the anionic moiety that may be used in this invention includes those derived from salts of C₆-C₁₀ fatty acids and salts such as cumeric sulfonate, 2-hydroxy benzoate para-toluene, sodium linear tridecylbenzene sulfonate, sodium or potassium dodecyl benzene sulfonate, potassium octadecylbenzene sulfonate, sodium lauryl sulfate, mixtures thereof and the like. The most preferred anionic moiety is derived from sodium dodecyl benzene sulfonate and made available from suppliers like Stepan Company. A more detailed description of the well known types of cationic and anionic moieties that may be used in this invention may be found in U.S. Pat. No. 6,268,324, the disclosure of which is incorporated herein by reference.

As to the cationic moiety, typically from about 0.1 to about 35.0%, and preferably, from about 1.0 to about 20.0%, and most preferably, from about 2.0 to about 15.0% by weight cationic moiety is used, based on total weight of cleaning concentrate and including all ranges subsumed therein.

The anionic moiety typically makes up from about 0.01 to about 8.0%, and preferably, from about 0.05 to about 5.0%, and most preferably, from about 0.1 to about 2.5% by weight of the cleaning concentrate, based on total weight of cleaning concentrate and including all ranges subsumed therein.

The optional additives that may be used in this invention include stabilizers, sequestrants and bleaches. Preferred stabilizers which may be used in this invention include, for example, sodium xylene sulfonate, parrafin sulfonate, sodium lauryl sulfate, naphthalene sulfonate, mixtures thereof and the like, with sodium xylene sulfonate being most preferred. The sequestrants that may be used in this invention include, for example, ammonium pyrophosphate, sodium polymetaphosphate, sodium tripolyphosphate, potassium tripolyphosphate, 2-phosphono-butane tricarboxylic acid-1,2,4, polyacrylic acids (e.g., Acusol 445), mixtures thereof and the like.

The bleaches that may be used in the cleaning compositions of the present invention include any of those that may be used in a cleaning composition. Such bleaches include benzoylperoxide, hydrogen peroxide, acylperoxides, sodium percarbonate, sodium perborate, sodium hypochlorite, mixtures thereof and the like.

The amount of optional additives used in the cleaning concentrate of the present invention is typically from about 0.5 to about 10.0% by weight for the stabilizers; from about 0.5 to about 10.0% by weight for the sequestrants; from about 1.0% to about 40.0% by weight for the bleach, based on total weight of the cleaning concentrate and including all ranges subsumed therein. The balance of the concentrate is substantially water, wherein water typically makes up from about 35.0% to about 70.0%, and preferably, from about 35.0% to about 55.0%, and most preferably, from about 35.0% to about 45.0% by weight of the cleaning concentrate, and including all ranges subsumed therein.

When making the cleaning concentrate of the present invention, the components (e.g., cationic and anionic moieties, alkaline source, water) are added to a mixing vessel (in no particular order) and stirred, for example, under conditions of moderate sheer at ambient temperature and atmospheric pressure. The resulting cleaning concentrate may be sold as is and with instructions to dilute with water (to form a cleaning composition) prior to use and/or instructions to use the cleaning concentrate with a foam producing device such as an eductor. It is also within the scope of this invention to sell the cleaning composition directly to the end users.

In a most preferred embodiment, the cleaning composition of the present invention has a viscosity from about 1.0 to about 20.0 cps, and preferably, from about 1.0 to about 15.0 cps, and most preferably, from about 1.0 to about 12.0 cps, including all ranges subsumed therein. Such a viscosity is based on viscosity measurements that may be taken with a Brookfield Viscometer, at ambient temperature, and with Spindle No. 1 from the LV set.

When generating a foam with the cleaning composition of the present invention, any of the conventional foam generating systems or pumps (i.e., foam-producing apparatus) may be used. Such systems or pumps include eductors and foam producing devices similar to those described in U.S. Pat. Nos. 3,337,195 and 3,823,727, the disclosures of which are incorporated herein by reference. As previously described the cleaning composition of the present invention may be used with a foam producing apparatus not comprising an air compressor.

Therefore, if desired, the cleaning concentrate of the present invention may be used with an eductor such as those described in U.S. Pat. Nos. 5,159,958, 5,673,725, 5,927,338 and World Patent Application WO 94/04857, the disclosures of which are incorporated herein by reference. In an especially preferred embodiment, however, the cleaning composition of the present invention is used with a high volume foamer (having a compressed air source) like those sold under the name LC Foamer and made commercially available by Lafferty Equipment Mfg., Inc.

When cleaning a soiled surface with the cleaning composition of the present invention, the cleaning composition may first be premixed or concentrate may be fed to or drawn by the foam producing apparatus and mixed with water at a point near or within the apparatus. Regardless of how the cleaning composition is produced, air is mixed with the cleaning composition to produce a foamed cleaning composition, the air being either atmospheric air, air generated from a compressor or both. The foamed cleaning composition is then applied, typically with a spray wand, to the soiled surface targeted for cleaning.

The water used to make the foamed cleaning composition is typically from about 45° C. to about 80° C., and preferably, from about 55° C. to about 65° C. The typical water pressure within the foam producing apparatus is from about 10 psi to about 400 psi, and preferably, from about 30 psi to about 200 psi. The air being fed into the foam producing apparatus is usually pressurized from about 20 psi to about 180 psi, and preferably, from about 25 psi to about 150 psi, and most preferably, from about 25 psi to about 120 psi, including all ranges subsumed therein. The preferred conduit for feeding foamed cleaning composition to the spray wand has an inside diameter from about 1.25 cm to about 5.0 cm, and preferably, from about 1.25 cm to about 2.75 cm, the conduit preferably being less than about 25 meters in length, and most preferably, less than about 15 meters in length.

When applying the foamed cleaning composition to the soiled surface targeted for cleaning, the foamed cleaning composition typically exits the foam generating apparatus at an exit pore (e.g., spray wand) at a rate from about 5.0 to about 30.0 meters per second. The foamed cleaning composition is, for example, sprayed or applied onto the surface from a distance that prevents the foamed cleaning composition from interfering with the user or users of the foam generating device. When applied to the soiled surface, about 60 to about 230 mls, and preferably, from about 70 to about 120 mls of foamed cleaning composition is applied to every square meter of surface. The foamed cleaning composition produced typically is applied to the surface at a thickness from 0.2 to about 3.0 cm (preferably from about 0.2 to about 1.0 cm) and has foam (e.g., bubble) diameters from about 0.75 to about 2.5 mm.

After applying the foamed cleaning composition to the soiled surface, the foamed cleaning composition is left on the wall from about 5.0 to about 45 minutes, and preferably, from about 10.0 to about 30 minutes. Unexpectedly, the cleaning composition of this invention displays excellent adhesion to a surface (such as a non-horizontal surface), despite its relatively low viscosity characteristics. While on the soiled surface, and in a preferred embodiment of this invention, the soiled surface having foamed cleaning composition thereon may be subjected to a second application of foamed cleaning composition. The amount of foamed cleaning compositions applied during the second application is preferably from about 10.0% to about 50.0%, and preferably, from about 15.0% to about 30.0% of the amount of foamed cleaning composition first applied to the surface. After the foamed cleaning composition is applied, the soiled surface with formed cleaning composition thereon may then be rinsed with water in order to obtain a surface substantially free of soil.

The Examples which follow are provided to facilitate an understanding of the present inventions. The Examples are not intended to limit the scope of the inventions as described in the claims.

### EXAMPLE 1

The following cleaning concentrate was prepared by mixing in a mixing vessel the following components:

| Ingredient | Wt. % |
|---|---|
| Water, Deionized | 38.0 to 42.0 |
| Sodium Xylene Sulfonate Sodium | 2.40 to 2.60 |
| Dodecyl Benzene Sulfonate | 0.62 to 0.68 |
| C8 Fatty Acid | 0.23 to 0.27 |
| Potassium Hydroxide, 45% | 3.80 to 4.20 |
| Amine Oxide | 5.00 to 5.40 |
| Potassium Hydroxide, 45% | 16.00 to 18.00 |
| Polyacrylic Acid | 0.710 to 0.790 |
| Sodium Tripolyphosphate | 2.35 to 2.65 |
| Sodium Hypochlorite, 13.5% | 25.5 to 28.5 |

The cleaning concentrate of this example was mixed with 96.0% by weight deionized water to produce a cleaning composition.

### EXAMPLE 2

The cleaning composition of Example 1 was mixed with water and air using a wall mounted Lafferty LC Foamer (Model No. 915105) and applied to a vertical stainless steel panel. A chemical draw tube containing a clear pink orifice tip was placed in a vessel containing the cleaning composition. Water and air connections were turned on and adjusted for application of foam to the vertical stainless steel panel. Vertical cling was noted by observing the percentage of panel coverage 10 minutes after the application of foamed cleaning composition stopped. At 60 psi water feed pressure and 60 psi air pressure a uniform and even coverage of foam was applied. After 10 minutes of contact time, at least 65% of the original coated surface remained covered in foamed cleaning composition.

The experimental results unexpectedly indicate that the foamed cleaning composition of this invention displays excellent adhesion properties despite the low viscosity characteristics of the cleaning composition.

What is claimed:

1. A cleaning concentrate comprising:
(a) optionally, an alkaline source;
(b) a cationic moiety; and
(c) an anionic moiety
wherein the cleaning concentrate is substantially free of isostearic acid and an organic solvent and the cationic and anionic moiety form rod micellar formations.

2. The cleaning concentrate according to claim 1 wherein the alkaline is an alkaline or alkali earth metal hydroxide, sodium carbonate, sodium tripolyphosphate, sodium silicate, ammonium hydroxide or a mixture thereof.

3. The cleaning concentrate according to claim 1 wherein the cationic moiety is selected from the group consisting of an amine, quaternary amine, amine oxide and mixtures thereof.

4. The cleaning concentrate according to claim 1 wherein the anionic moiety is derived from a salt of a C₆-C₁₀ fatty acid or from a sodium or potassium docecyl benzene sulfonate.

5. A method for cleaning a soiled surface comprising the steps of:
(a) applying to the surface a cleaning composition having a viscosity from about 1.0 to about 20.0 cps and comprising:
(i) optionally, an alkaline source;
(ii) a cationic moiety; and
(iii) an anionic moiety,
the cationic moiety and the anionic moiety result in rod micellar formations;
(b) allowing the cleaning composition to act on soil on the surface wherein about 60 to about 230 mls of the cleaning composition is applied to every square meter of the surface with a foam producing device to produce a foam layer having a thickness from about 0.2 to about 3.0 cm and a foam diameter from about 0.75 to about 2.5 mm.

6. The method for cleaning a soiled surface according to claim 5 wherein the method further comprises the step of applying additional cleaning composition to the soiled surface comprising cleaning composition.
